(19) United States
(12) Patent Application Publication
(10) Pub. No.: US 2004/0215506 A1
(43) Pub. Date: Oct. 28, 2004

(54) Interactive commercials as interface to a search engine

(76) Inventors: Richard Mcewan, Dana Point, CA (US); Thomas Blakeley, San Clemente, CA (US)

Correspondence Address: LAVA GROUP LAW BY SMITH & FROHWEIN, LLC, P.O. BOX 88148, ATLANTA, GA, 30356, US

(21) Appl. No.: 09/856,536

(22) PCT Filed: Mar. 24, 2001
(86) PCT No.: PCT/US00/07915

(51) Int. Cl. G06F 17/60

(52) U.S. Cl. 705/14

(57) ABSTRACT

A user submits a search request to an Internet or other network search engine from within an e-mail client. The software for performing this task is preferably provided as part of e-mail advertisement (15) sent to the user (recipient). The advertisement preferably includes a first portion having a first branding graphic (20), and a second portion that receives to a search string designated by the recipient (50). In especially preferred embodiments the search engine returns the search results to the recipient within the e-mail client.

### FIELD OF THE INVENTION

The field of the invention is electronic direct marketing.

### BACKGROUND OF THE INVENTION

Expansion of the Internet over the last few years has made enormous amounts of information available to users all over the world. While in many respects this has been a major step forward, difficulties in searching all that information have still not been resolved, and to some extent further expansion of the Internet only exacerbates the problem.

It is likely that most Internet searching is still performed using simplistic keyword type search engines such as Yahoo!™. There are other, second generation search engines such as Northern Light™ that try to categorize the information in ways that increase accessibility, but even these search engines are often very unsatisfactory. Among other things, they do nothing to guide individuals who may be loading data onto the Internet to categorize and store the information in a consistent manner. U.S. Pat. No. 6,035,294 to Fish (March 2000) discloses technology for a third generation search engine that appears to resolve many of these problems, and over the next several years promises to greatly improve searching on the Internet.

Although a very significant advancement in the art, even the Fish engine contemplates that users will access the searching functions through specialized interfaces on web sites designed for that purpose. Among other things, there appears to be no appreciation that searches could be instigated from within an e-mail (client) application.

Thus, there is a need to provide methods and systems by which a user can submit search requests to an Internet or other network search engine from within an e-mail client.

### SUMMARY OF THE INVENTION

The present invention provides embodiments in which a user submits a search request to an Internet or other network search engine from within an e-mail client.

In preferred embodiments, the software for performing this task is provided as part of an e-mail advertisement sent to the user (recipient). The advertisement preferably includes a first portion having a first branding graphic, and a second portion that receives a search string designated by the recipient. In especially preferred embodiments the search engine returns the search results to the recipient within the e-mail client.

Various objects, features, aspects, and advantages of the present invention will become more apparent from the following detailed description of preferred embodiments of the invention, along with the accompanying drawings in which like numerals represent like components.

### BRIEF DESCRIPTION OF THE DRAWING

FIG. 1 is a schematic of an e-mail message according to the claimed subject matter.

FIG. 2 is a schematic of a search results portion of an e-mail message.

FIG. 3 is a flowchart of a preferred method.

### DETAILED DESCRIPTION

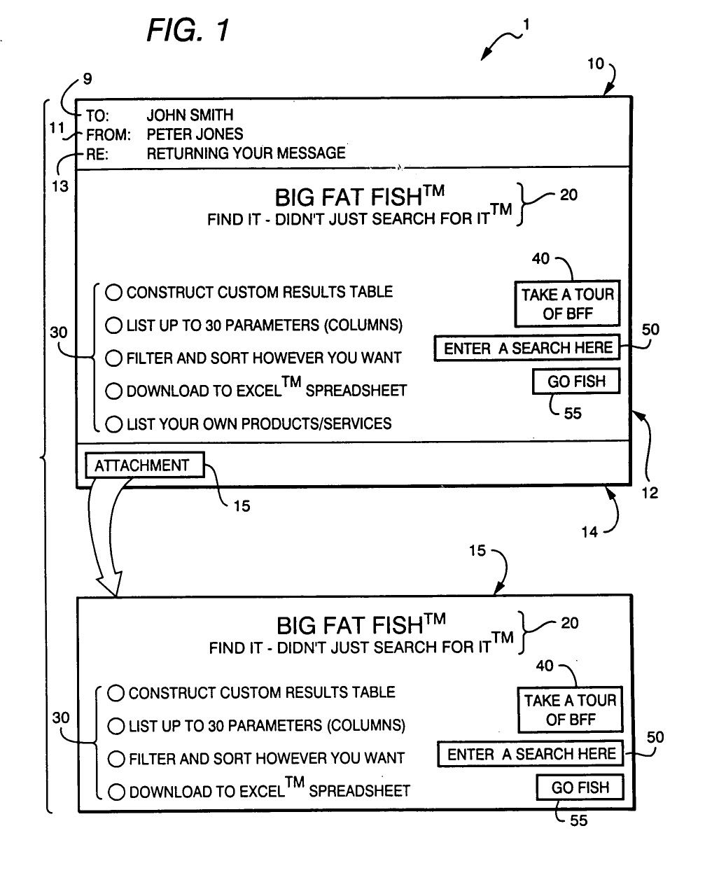

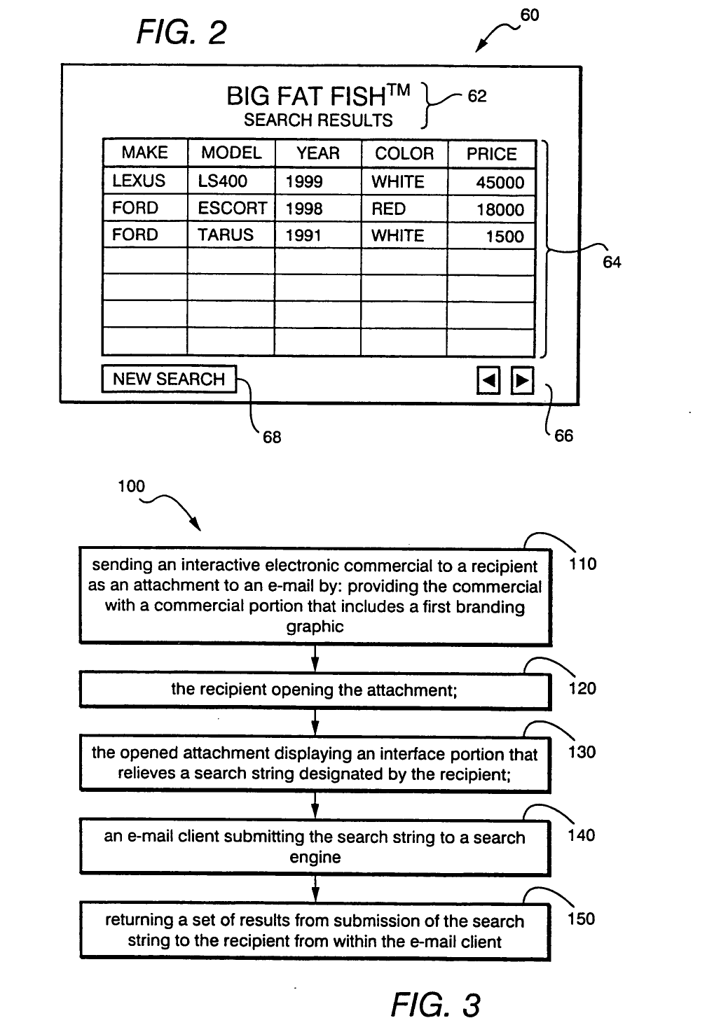

In FIG. 1 an e-mail message 1 generally contains a header portion 10, a message portion 12, and an attachment portion 14 including an attachment 15. One or both of the message portion 12 and attachment 15 include a product or advertiser name section 20, value proposition 30, a hyperlink portion 40, a search string input section 50, a search initiator button 55. FIG. 2 generally depicts a search results section 60 that can be included in either message 1 or another e-mail message.

The header portion 10 is likely known in the art. There is at least a “To:” section 9, a “From:” section 11, and a “Re:” section 13, the content of which is likely controlled by the sender of the e-mail 1, and the format of which is likely controlled by the recipient's e-mail client. By way of illustration, typical e-mail clients are Eudora™ and Microsoft™ Outlook™.

The product of advertiser name section 20 preferably introduces the product(s) and/or service(s) being offered. In this instance the advertisement is directed to a new service called BigFatFish.com, which offers a third generation search engine such as that disclosed in U.S. Pat. No. 6,035,294. Other contemplated products or services include anything that can be offered, including consumer goods (toothpaste, pets, building supplies, automobiles, etc), financial and insurance services, vacations, theatre tickets, and so on. It is especially contemplated that more than one type of goods or services can be offered, providing cross branding to the advertisers.

The value proposition section 30 provides the recipient with information on the advertised items. Presumably the advertiser will include a catchy image or slogan, or perhaps a list of features and benefits. There may be a price listed, as well as some sort of discount or other incentive to act within a particular time frame.

The hyperlink portion 40 provides a link to a web page, perhaps of an advertiser, or a selling agent, or perhaps a company that transmitted the e-mail message. There may be many such hyperlinks, and they need not have any conceptual connection with anything else included in the e-mail 1.

The search string input section 50 and search initiator button 55 cooperate to receive an input search string from the e-mail recipient, and initiate a search on a search engine. The search string may be structured in some manner, but more preferably is of the free-form variety. Thus, a viable search string entered by a recipient may be “red mercedes”, which would likely initiate a search for Mercedes™ cars that are red. Significantly, it is not essential that the e-mail client be HTTP compliant, or have any other access to the network, special or otherwise. One option, for example, is that the e-mail client will send an e-mail request to a server that does access to the network, the server would submit the search and obtain the results, and then send the results to the recipient in another e-mail. More preferably, however, the e-mail client would act as a browser, and would itself submit the search, retrieve the results, and display the results to the searcher/recipient. Such displaying of results is preferably accomplished by sending the recipient another e-mail that includes the search results, although it is contemplated that e-mail clients could be written so that delivered and/or opened e-mail could be updated on the fly by the sender of the e-mail, or by another entity.

The search engine to which the search string is submitted is not limited to anything in particular. Thus, it is contemplated that the search would be submitted to a search engine available through another portal, such as a web page of the Internet. This is true of the BigFatFish™ type search engine. It is, however, also contemplated that the search engine would be available only through the search string input section 50.

In various aspects of preferred embodiments, it is contemplated that the search string being used is presented to the recipient in the e-mail 1. For example, some of the bullet points in value proposition 30 may contain keywords that are submitted through the search string input section 50 when clicked upon. In other instances there may be another section (not shown) that lists keywords of interest. Thus, it is contemplated that the search string can be designated by the user in any suitable manner, including entering the search string in an entry box, or selecting the search string from a list of terms.

The search results section 60 preferably includes a title 62, a search results table 64, a navigation aids 66, and a new search button 68. The search results table 60 preferably displays in tabular form 64 a set of search results returned in response to the search. Tables are excellent means of displaying information, especially where the different rows each contains information on a different item identified by the search. It is contemplated, for example, that search results of non-tabular oriented search engines such as Yahoo!™ can be reformatted into a tabular format for presentation in search results section 60. In a system such as BigFatFish™, the cells of the search results table can themselves be active hyperlinks. Thus, such cells can link to pictures or other images, videos, or an audio clip that motivates the recipient to order a product from among a listing of products contained in the table. Such information can be played using a player that is intrinsic or extrinsic to the e-mail 1. Also in a system such as BigFatFish™, the product offerings or other items displayed in the different rows may or may not be related to one another by manufacturer, vendor, distributor, etc.

In FIG. 2, a search results section 60 generally includes a banner or title portion 62, a data portion 64 and navigation aids 66. The data depicted here is shown in table format, but is contemplated to be presented in any format whatsoever, including memo type text fields, audio, video, picture, or any other objects. The title and navigation portions 62 and 66 are entirely optional. It is contemplated that the results section 60 may include other sections (not shown) as well, including additional branding graphics, hyperlinks, new search buttons, etc.

In FIG. 3, a preferred method 100 comprises: sending an interactive electronic 110 commercial to a recipient as an attachment to an e-mail by providing the commercial with a commercial message portion that includes a first branding graphic 110; the recipient opening the attachment 120; the opened attachment displaying an interface portion that receives a search string designated by the recipient 130; an e-mail client submitting the search string to a search engine 140; and returning a set of results from submission of the search string to the recipient from within the e-mail client 150.

Thus, specific embodiments and applications of interactive electronic commercials have been disclosed in which a user submits a search request to an Internet or other network search engine from within an e-mail client. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

1. An interactive electronic commercial sent to a recipient as an attachment to an e-mail comprising:
a commercial message portion that includes a first branding graphic;
an interface portion that receives a search string designated by the recipient;
a search engine interface; and
a searching routine that submits the search string to a search engine via the search engine interface, and returns results to the recipient from within an e-mail client, without using a browser.

2. The commercial of claim 1 wherein the search string is selected from a list of search strings presented to the recipient in the commercial.

3. The commercial of claim 1 wherein the interface portion contains a space into which the recipient types the search string.

4. The commercial of claim 1 wherein the search engine is a commercial searching facility available through a portal other than the commercial.

5. The commercial of claim 1 wherein the search engine is a commercial searching facility available through a web page of the Internet.

6. The commercial of claim 1 wherein the search engine further comprises a graphical hyperlink to an internet site.

7. The commercial of claim 1 further comprising an ordering routine through which the recipient orders a product.

8. The commercial of claim 1 further comprising a results routine that returns a set of results to the recipient through an interface provided by the commercial based upon submitting the search string to the search engine.

9. The commercial of claim 8 further comprising an ordering routine through which the recipient orders a product from among a listing of products contained in the set of results.

10. The commercial of claim 8 further comprising an audio containing clip that motivates the recipient to order a product from among a listing of products contained in the set of results.

11. The commercial of claim 10 having a playing routine by which the audio containing clip is played at will by the recipient.

12. The commercial of claim 1 where the commercial further includes branding graphics for multiple products.

13. The commercial of claim 1 where the commercial includes additional branding graphics for multiple products from unrelated vendors.

14. The commercial of claim 1 where the ordering routine involves taking ordering information for multiple products from unrelated vendors.

15. A method of sending an interactive electronic commercial to a recipient as an attachment to an e-mail, comprising:
providing the commercial with a commercial message portion that includes a first branding graphic;
the recipient opening the attachment;
the opened attachment displaying an interface portion that receives a search string designated by the recipient;
an e-mail client submitting the search string to a search engine; and
returning a set of results from submission of the search string to the recipient from within the e-mail client, without using a browser.

16. A method of sending an interactive electronic commercial to a recipient as an e-mail message, the method comprising:
providing an e-mail message to a recipient the email message including a commercial message portion;
the recipient opening the e-mail message;
the opened e-mail message displaying the commercial message portion and an interface portion, the interface portion being operable to receive a recipient designated search string;
an e-mail client that is operable to submit the recipient designated search string to a search engine; and
returning a set of results from submission of the search string to the recipient from within the e-mail client, without using a browser.
